(19) United States
(12) Patent Application Publication
(10) Pub. No.: US 2006/0207122 A1
(43) Pub. Date: Sep. 21, 2006

(54) Freeze dryer

(76) Inventors: Paul Stewart, Youngstown, NY (US); Ernesto Renzi, Youngstown, NY (US)

Correspondence Address: Ira Lee Zebrak;The BOC Group, Inc., Legal Services-IP, 575 Mountain Ave., Murray Hill, NJ, 07974, US

(21) Appl. No.: 11/080,596

(22) Filed: Mar. 15, 2005

(51) Int. Cl. F26B 25/00; F26B 5/06

(52) U.S. Cl. 34/242; 34/284

(57) ABSTRACT

A freeze dryer comprises a chamber having an opening through which containers can be inserted into the chamber, a door, and a mechanism for moving the door against the opening. A sealing mechanism comprises a first gasket extending around the opening, and a second gasket extending around the first gasket. The second gasket is moveable between a first position at which the first gasket forms an airtight seal with the door and a second position at which the second gasket forms an airtight seal with the door.

### FIELD OF THE INVENTION

The present invention relates to apparatus for closing an opening in a chamber of a freeze dryer or the like, and to a freeze dryer incorporating the same.

### BACKGROUND OF THE INVENTION

Freeze drying is a process that removes from a product water in the form of ice. In the freeze drying process, the product is frozen and, under vacuum, the ice sublimes and the vapour flows towards a condenser. Ice subsequently condensed on the condenser can be removed in a later stage. Freeze drying is particularly useful in the pharmaceutical industry, as the integrity of the products is preserved during the freeze drying process and product stability can be guaranteed over relatively long periods of time.

Freeze dryers thus typically incorporate a pressure vessel having a freeze drying chamber for receiving a plurality of containers or vials containing the product to be freeze dried. The chamber usually includes a number of shelves, each of which can be raised and lowered within the chamber. To load the shelves, the shelves are initially collapsed in the lower portion of the chamber, and the uppermost shelf is first moved into a loading position. After that shelf has been loaded, the mechanism automatically raises the loaded shelf to enable the next shelf to be moved to the loading position. This moving sequence continues until the chamber loading has been completed. To unload the chamber, the loading sequence is reversed, with the lowermost shelf being unloaded first.

Access to the chamber for automated loading and removal of vials is through a rectangular opening, or slot, formed in a wall or in the main door of the chamber. A moveable slot door closes the slot. To enable vials to be inserted into the chamber, the slot door is vertically raised relative to the slot by moving the slot door along guide tracks. A loading mechanism located opposite the slot door pushes vials from a conveyor onto a shelf of the chamber. The vials may be loaded row by row onto a shelf, a number of rows at a time, or a complete shelf full at a time, or a dual vial pack per shelf. The loading mechanism is subsequently withdrawn and the shelf raised to enable another shelf to be moved into position for loading. Once loading has been completed, the slot door is lowered to close the slot to enable the chamber to be evacuated for subsequent freeze drying of the contents of the vials.

In order to provide a vacuum seal around the slot door, a fixed gasket is typically provided around the periphery of the slot door. An external locking mechanism is provided to restrain the slot door against the fixed gasket to form an airtight seal. As the chamber is evacuated, the slot door is held against the fixed gasket by the locking mechanism to maintain the airtight seal. Once the freeze drying has been completed, the chamber is returned to an ambient pressure. The locking mechanism is released and the slot door raised to enable the vials to be removed from the chamber, typically in the same manner as they were loaded into the chamber, using an unloading mechanism.

Periodically, sterilisation of the chamber is required to maintain a sterile environment within the freeze dryer. Steam sterilisation of the chamber is performed by lowering the slot door to close the slot, and conveying to the chamber a stream of pressurised steam, typically at a temperature of around 130° C. and at a pressure of around 2.5 bar. The elevated pressure within the chamber during the sterilisation process tends to urge the slot door away from the fixed gasket, causing hot steam to escape from the chamber. In order to prevent this safety hazard, the external locking mechanism is also used to restrain the slot door against the fixed gasket during sterilisation and thus maintain the airtight seal around the slot.

Pharmaceutical freeze dryers are usually at least partially housed in a clean room, with the loading and unloading mechanism being located in a sterile environment, for example an isolator, adjacent the clean room environment. Consequently, the use of such a locking mechanism may be detrimental to the sterile environment of the clean room and may lead to contamination of the chamber of the freeze dryer when the slot door is raised to enable vials to be loaded into the freeze dryer. Such locking mechanisms also tend to be relatively bulky and complex devices.

It is an aim of at least the preferred embodiment of the present invention to seek to solve these and other problems.

### SUMMARY OF THE INVENTION

In a first aspect of the present invention, an apparatus is provided for closing an opening in a chamber, the apparatus comprising a door, means for moving the door against the opening, a first, preferably fixed, gasket extending around the opening, a second gasket extending around the first gasket, and gasket moving means for moving at least a sealing surface of the second gasket relative to the door between a first position at which the first gasket forms an airtight seal with the door and a second position at which the second gasket forms an airtight seal with the door.

By moving the sealing surface of the second gasket towards the second position, an airtight seal with the door can be still formed even in the event that an elevated pressure within the chamber has urged the door away from the first gasket. Where a hot gas is supplied to the chamber at an elevated pressure, for example, for steam sterilisation of the chamber the second gasket can thus inhibit the escape of the hot steam from the chamber, thereby improving safety. In addition, as the fixed gasket is located between the opening and the second gasket, sterilisation of the fixed gasket can be performed simultaneously with the sterilisation of the chamber. Furthermore, no locking mechanism is required to retain the door against a fixed gasket during sterilisation.

The sealing surface of the second gasket can be moved in a number of different ways. In one example, the second gasket is an inflatable gasket, to which a fluid, such as a compressed gas, can be supplied so that, as the gasket is inflated, the sealing surface of the second gasket moves towards the door. The second gasket can then be subsequently deflated to move the sealing surface away from the door and thus break the seal. In another example, the second gasket is located in a channel extending about the first gasket, and a fluid, such as a compressed gas, is supplied to the channel to move the second gasket towards the door. The compressed gas can be subsequently released from the channel, for example by operation of a valve.

A fixed member is preferably provided for restricting the movement of door away from opening. The fixed member may be conveniently provided by a frame connected to the chamber and extending at least partially about the opening.

The use of a moveable gasket is particularly advantageous as part of a sealing mechanism for a slot door of a freeze dryer, and so in a second aspect the present invention provides a freeze dryer comprising a chamber having a slot through which containers can be inserted into the chamber, a slot door, means for moving the slot door against the slot, a first, preferably fixed, gasket extending around the slot, a second gasket extending around the first gasket, and gasket moving means for moving at least a sealing surface of the second gasket relative to the slot door between a first position at which the first gasket forms an airtight seal with the slot door and a second position at which the second gasket forms an airtight seal with the slot door.

The means for moving the door preferably comprises means for moving the door in a direction transverse to the slot to permit access to the chamber, and means for rotating the door as it is moved transverse to the slot. By causing the slot door to rotate as it is moved away from the slot, the rear surface of the slot door is exposed to allow manual or automatic cleaning and sterilization of the rear surface without the need to remove the door from the dryer.

The rotating means comprises a cam attached to the door for engaging a curved guide to cause the door to rotate. The guides are preferably in the form of tracks provided on facing sidewalls of the dryer. The door moving means preferably engages or is connected to a pivot of the door. Two pivots may be provided, one on either side of the door, each being associated with a respective cam and guide. The rotating means may be arranged to rotate the door during movement thereof from a closed position in which the door is positioned against the opening, so that the door is gradually rotated as the slot is opened. Alternatively, the door moving means is arranged to move the door from the closed position to a second open position at which the cam engages the guide, the slot being preferably fully exposed by the door at the second position. Means may be provided for automatically stopping the door moving means at the second position. This can enable the door to be stopped at the second position to enable containers or vials to be inserted in and removed from the chamber with minimal disturbance of airflow by the door.

Thus, the door rotates during movement of the door from the second position to a third, open arrangement. Means may be provided for automatically stopping movement of the door at the third position. The means for stopping the door in the second and third positions may be provided by sensors or switches located at these positions for detecting the presence of the door moving means, the sensors being arranged to output signals to a controller for controlling the door moving means.

Each cam is attached to an arm connected at one end thereof to the pivot, and preferably comprises a roller rotatably mounted on the arm. Each pivot is connected to the door at or towards one end thereof so as to cause the other end of the door to swing away from the chamber as the door is moved away from the slot.

The door moving means comprises means for raising and lowering the door, and may include means for isolating at least part thereof from the ambient atmosphere.

### BRIEF DESCRIPTION OF THE DRAWINGS

Preferred features of the present invention will now be described with reference to the accompanying drawings, in which:

FIG. 1 is a front view, partially in section, of an embodiment of a slot door assembly, with the door in a first, closed position;

FIG. 2 is a side view, partially in section, of the door assembly as shown in FIG. 1;

FIG. 3 is a side view, partially in section, of the door assembly with the door shown in a second, open position;

FIG. 4 is a side view, partially in section, of the door assembly with the door shown in a third, open position;

FIG. 5 is a simplified front view of part of the sealing arrangement surrounding the slot closed by the slot door assembly of FIG. 1;

FIG. 6 is a section view taken along line A-A in FIG. 5, with the door spaced from both of the fixed and moveable gaskets of the sealing arrangement;

FIG. 7 is a section view taken along line AA in FIG. 6, illustrating an airtight seal formed between the door and the moveable gasket;

FIG. 8 is a side cross-sectional view illustrating the door positioned against the slot and a mechanism for moving the door away from the slot as it is raised and lowered; and

FIG. 9 is a section view taken along line AA in FIG. 6, illustrating an airtight seal formed between the door and the fixed gasket.

### DETAILED DESCRIPTION OF THE INVENTION

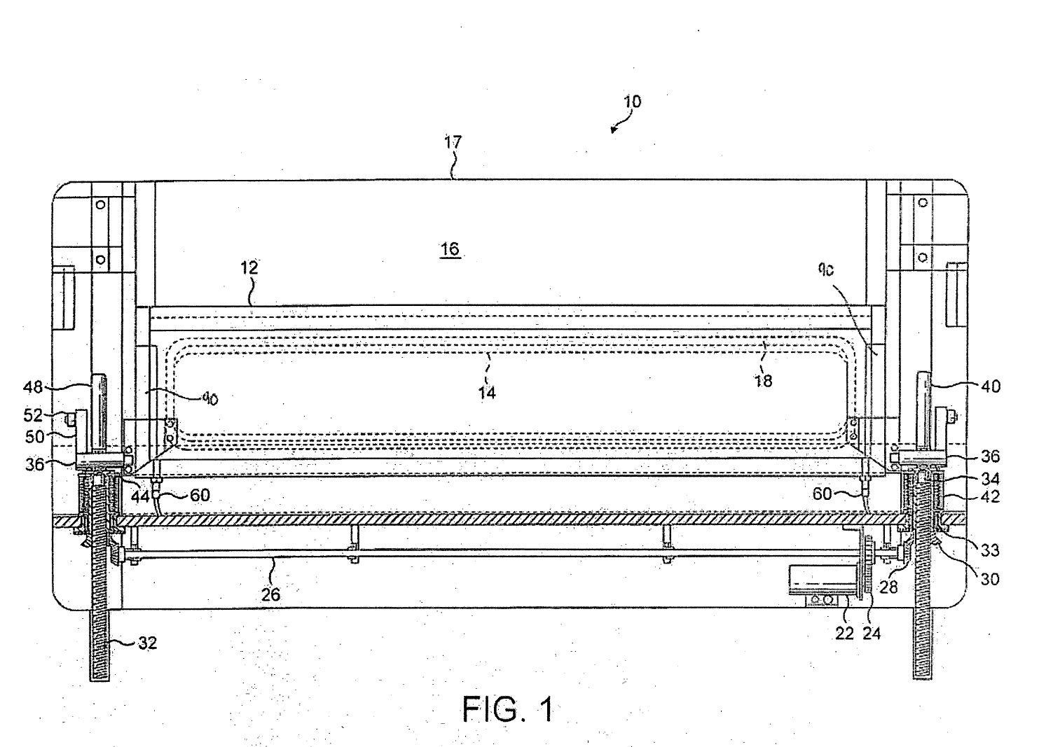

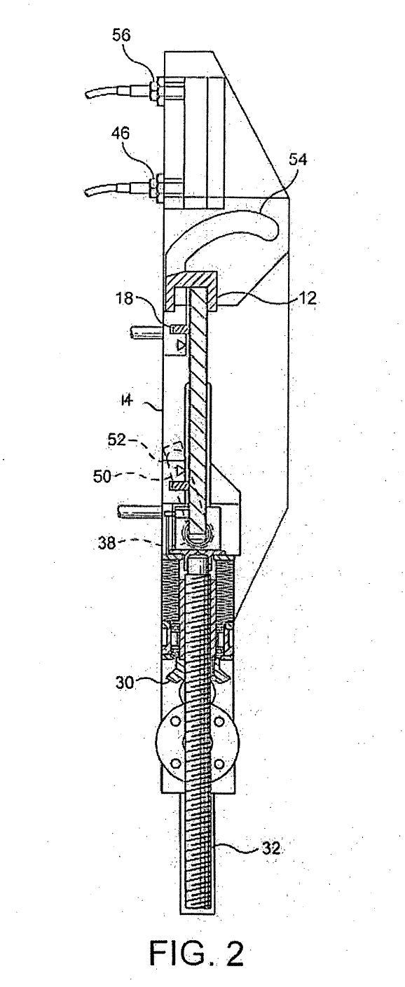

With reference to FIGS. 1 and 2, a slot door assembly 10 comprises a rectangular slot door 12 for closing a slot 14 formed in a wall or main door of a chamber 16 of a freeze dryer 17 or the like. FIGS. 1 and 2 illustrate the door 12 in a closed position against the slot 14. In this position, a sealing arrangement 18 extending around the slot 14 selectively forms an airtight seal with the door 12, as described in more detail below.

A mechanism 20 is provided for moving the door 12 relative to the slot 14 to enable containers, such as vials or ampoules, to be inserted into and removed from the chamber 16 through the slot 14. The mechanism 20 is configured to raise and lower the door 12 relative to the slot 14. The mechanism 20 comprises a drive motor 22 connected by a timing belt or gear assembly 24 to a drive shaft 26. Gear wheels 28 attached to the ends of the drive shaft 26 intermesh with gear wheels 30 each located on a respective lead screw 32, the lead screws 32 being provided on respective sides of the assembly 10 and supported by bearings 33. Each lead screw 32 may be a normal thread lead screw or a ball screw spindle, depending on the required speed at which the slot door 12 is to be raised and lowered.

The upper end 34 of each lead screw 32 engages a pivot pin 36 attached to a side of the slot door 12. In the arrangement shown in FIGS. 1 and 2, each pin 36 passes through an aperture 38 formed in a cylindrical member 40 located on the upper end of the lead screw 32.

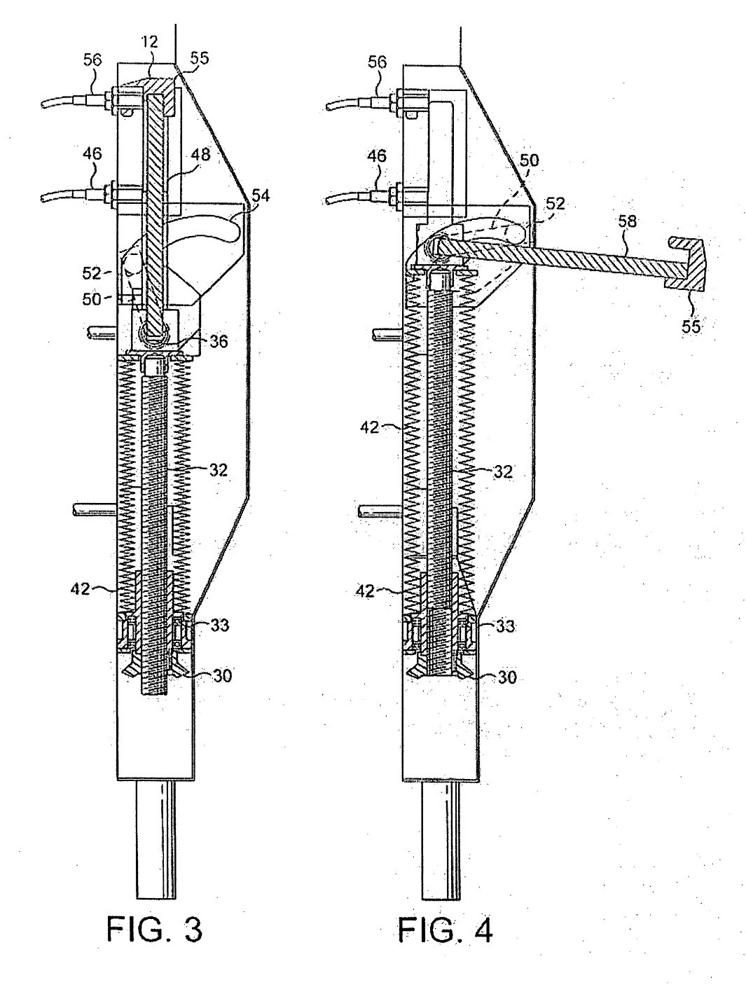

To move the slot door 12 from the closed position shown in FIG. 2 to an open, loading position as shown in FIG. 3, the motor 22 is operated to cause the drive shaft 26 to rotate in a first direction. Rotation of the gear wheels 28, 30 draws the lead screws 32 upwards, which in turn move the cylindrical members 40 upwards to raise the slot door 12, thereby exposing the slot 14. Each lead screw 32 is isolated from the ambient atmosphere, and thus from the surrounding sterile environment, by a surrounding bellows 42. One end of the bellows 42 is attached to the base 44 of the cylindrical member 40, and the other end of the bellows 42 is fixed proximate the bearings 33 so that the bellows 42 expands -as the slot door 12 is raised.

Raising of the slot door 12 to the open loading position shown in FIG. 3 is detected by a first sensor or switch 46, which detects the presence of the upper end 48 of the cylindrical member 40 relative thereto. An output of the first switch 46 is fed to a controller (not shown), which may be arranged to stop the motor 22 once the slot door 12 is in the open loading position to enable vials to be inserted into and removed from the chamber 16. In the case of laminar air flow, the disturbance of the air flow is minimal during loading of the chamber 16.

As shown in FIGS. 1 to 3, the assembly 10 further comprises support arms 50, each support arm 50 being connected at one end thereof to a respective pivot pin 36. A cam roller 52 is rotatably mounted to the other end of each support arm 50. In the loading position, each cam roller 52 has just engaged a respective cam track 54 located on a respective side wall of the chamber 16. Each cam track 54 is curved such that, with further raising of the slot door 12 from the open loading position, the slot door 12 is caused to pivot about pivot pins 36 as the cam rollers 52 follow the cam tracks 54, moving the upper end 55 of the slot door 12 away from the chamber 16.

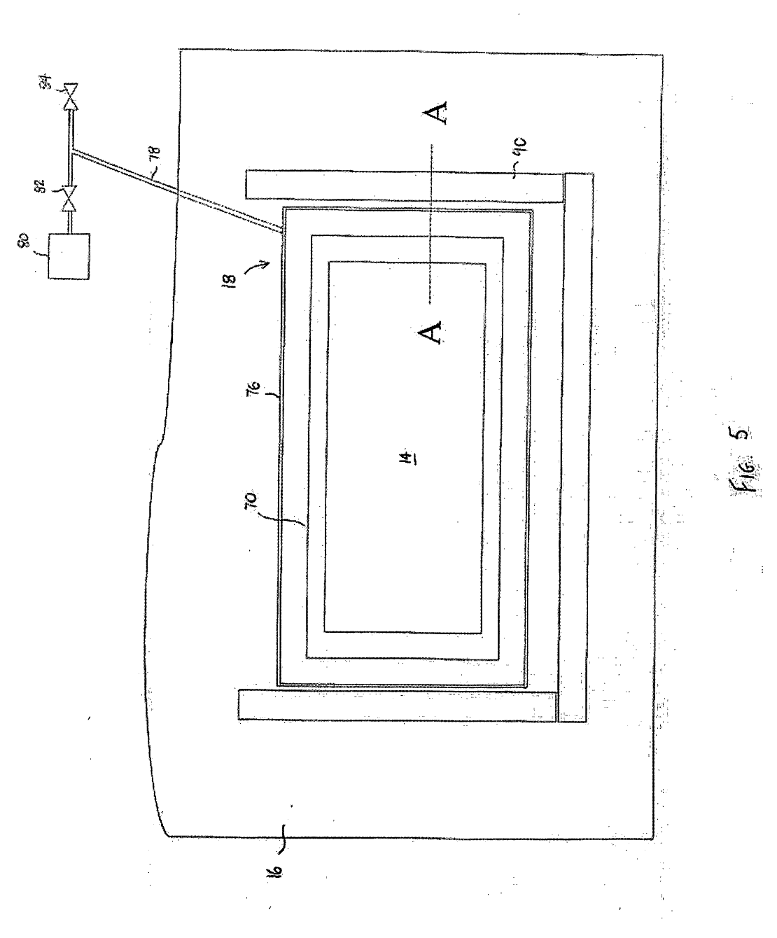

A second sensor or switch 56 is located above the first switch 46. Similar to the first switch 46, the second switch 56 detects the presence of the upper end 48 of the cylindrical member 40 relative thereto, and outputs a signal to the controller to stop the motor 22 when the door 12 is in the open, cleaning position shown in FIG. 4. In this open cleaning position, the slot door 12 is supported by the pivot pins 36 and cam rollers 50, and the rear surface 58 of the slot door is exposed, thereby enabling substantially the whole door to be manually or automatically cleaned and sterilized. Cleaning and sterilization may be automatically performed on a periodic basis, for example, every few days.

Following completion of the slot door cleaning and sterilization, the motor 22 is operated in reverse to lower the slot door 12. Third sensors or switches 60 are provided to detect the location of the slot door 12 in the closed position shown in FIG. 1, and to output signals to the controller to stop the motor 22.

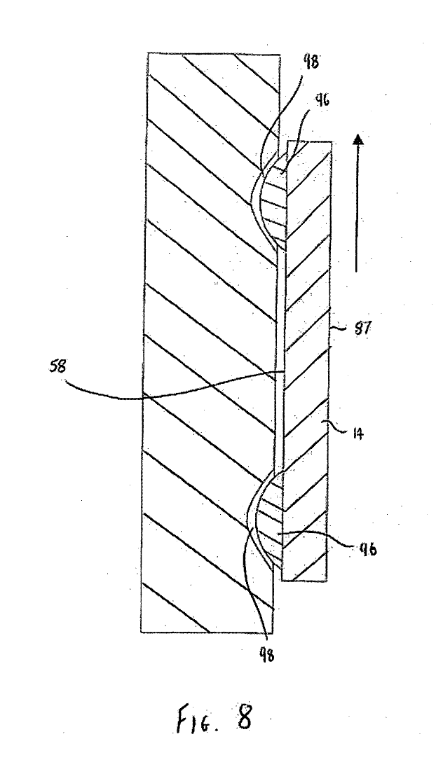

Operation of the sealing mechanism 18 for forming an airtight seal with the door 12 when positioned against the slot 14 will now be described with reference to FIGS. 5 to 8.

The sealing mechanism 18 comprises a first, fixed gasket 70 located in a groove 72 extending about the slot 14, and a second, moveable gasket 74 located in a channel 76 extending about the first gasket 72. A conduit 78 supplies a fluid, preferably a pressurised gas such as compressed clean air or compressed nitrogen, from a source thereof 80 to the channel 76. A valve 82 or other suitable mechanism is used to control the supply of the compressed gas to the channel 76. A second valve 84 is provided to enable compressed gas to be subsequently released from the channel 76.

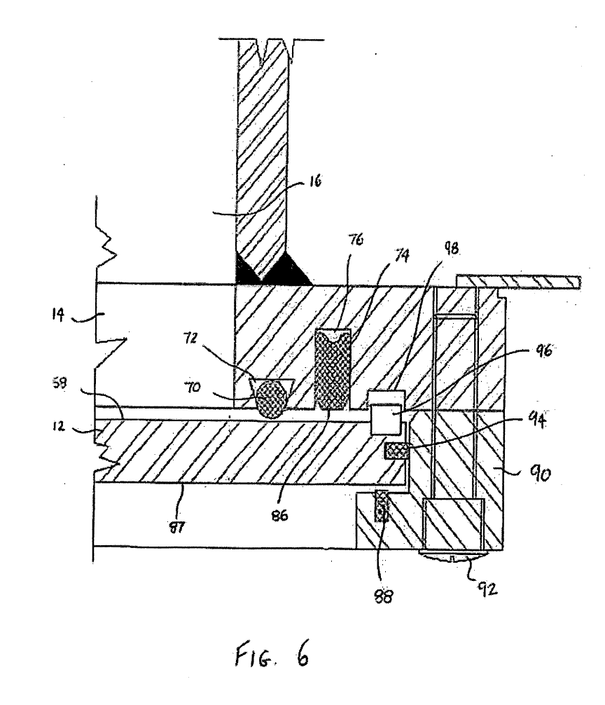

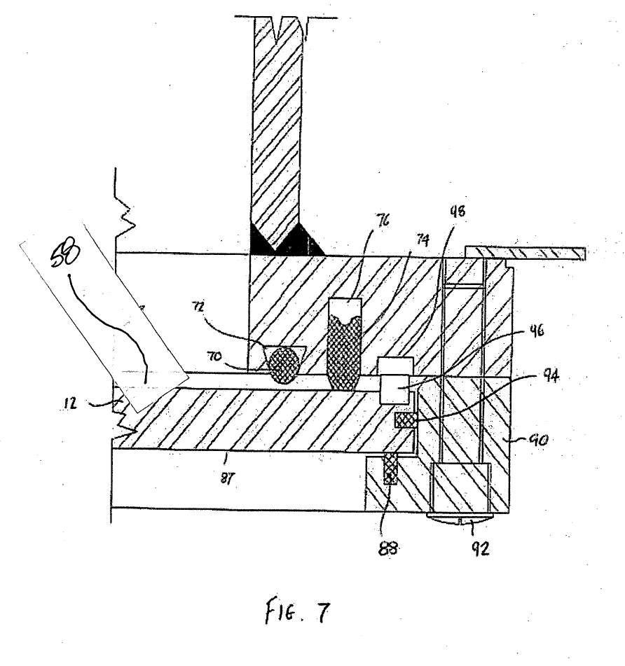

The second gasket 74 is initially positioned in a first, stowed position to enable the door 12 to be placed against the slot 14, as shown in FIG. 6. When the door 12 is positioned against the slot 14, it is preferable that neither the first gasket 70 or the second gasket 74 is in contact with the door 12. This avoids wear of the gaskets 70, 74 as the door 12 is raised and lowered by the mechanism 20. However, one or more of the gaskets 70, 74 may make relatively light contact with the door 12 as it is positioned against the slot 14.

In order to form an airtight seal with the door 12 for the duration of a sterilisation process, the first valve 82 is opened so that compressed gas is conveyed from the source 80 to the channel 76. Referring to FIG. 7, as the compressed gas enters the channel 76, the second gasket 74 is forced outwards from its stowed position towards the door 12, causing the sealing surface 86 of the second gasket 74 (FIG. 6) to come into contact with the rear surface 58 of the door 12 and form an airtight seal with the door 12.

Sterilisation of the chamber 16 can then commence. During sterilisation of the chamber 16, pressurised steam is typically conveyed to the chamber to create a pressure greater than atmospheric pressure, usually around 2.5 bar, with the chamber 16. This pressure tends to move the door 12 away from the slot 14. However, due to the pressure acting on the second gasket 74 from the compressed gas within the channel 76, typically around 4 bar, the second gasket 74 is urged by the compressed gas to move with the door 12, thereby maintaining the airtight seal with the door 12.

As the pressure is built up in the chamber 16, the door 12 is continually forced away from the slot 14 until the front surface 87 of the door 12 contacts a first guide strip 88, preferably formed from Teflon®, located on an L-shaped frame 90 attached to the housing of the chamber 16 by means of bolts 92. This serves to prevent further movement of the door 12 away from the slot 14, and thereby prevents the second gasket 74 from being forced out from the channel 76 under the pressure of the compressed gas therein. As shown in FIG. 6, a second guide strip 94, also preferably formed from Teflon®, is provided on the side wall of the door 12 to prevent the door 12 from sticking against the side wall of the frame 90 as it moves away from the slot 14. These two guide strips 88, 94 can also serve to guide the door as it is raised and lowered relative to the slot 14.

FIG. 7 illustrates the positions of the door 12 and the second gasket 74 with the second gasket 74 in a second, fully deployed position. Due to the space between the door 12 and the first gasket 70, steam used in the sterilisation process can pass between the first gasket 70 and the rear surface 58 of the door 12 up to the second gasket 74, sterilising the sealing surface of the first gasket 70 during the sterilisation process.

When the sterilisation has been completed, the chamber 16 is evacuated to remove the steam from the chamber 16. This creates a sub-atmospheric pressure within the chamber 16. The ambient pressure acting on the front surface 87 of the door 12 now forces the door 12 to move towards the slot 14 against the pressure of the compressed gas acting on the second gasket 74. The movement of the door 12 towards the slot 14 forces the second gasket 74 back towards its stowed position while maintaining the airtight seal with the door 12. Eventually, the rear surface 58 of the door 12 contacts the first, fixed gasket 70. Depending on the size of the vacuum created in the chamber, the pressure acting on the front surface 87 of the door 12 can urge the door 12 against the first gasket 70 so that an additional airtight seal becomes formed between the first gasket 70 and the door 12.

The chamber 16 is then returned to atmospheric pressure. As the pressures acting on the front and rear surfaces of the door 12 equalise, the strength of the seal formed between the door 12 and the first gasket 70 also reduces. The first valve 82 is closed and the second valve 84 opened to release the compressed gas from the channel 76, causing the second gasket to break its airtight seal with the door 12.

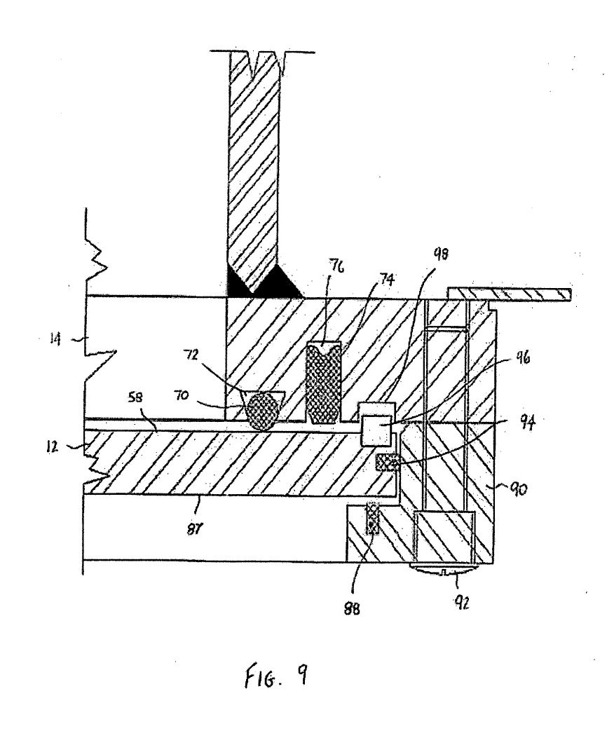

The door 12 can now be raised to permit the chamber 16 to be filled with vials for a subsequent freeze drying process. As both the first and second gaskets 70, 74 may remain in contact with the door 12, a mechanism is provided for 20 moving the door outwards as it is raised to prevent the rear surface of the door from rubbing against the gaskets 70, 74. For example, a spring-loaded push mechanism may be provided for pushing the door 12 away from the gaskets 70, 74 as it is moved relative to the slot 14. As illustrated in FIGS. 6 to 9, the rear surface 58 of the door 12 may be provided with one or more curved detents 96 on each side thereof, each detent 96 being located within a corresponding curved recess 98 formed in the housing of the chamber 12 when the door 12 is positioned against the slot 14. As the door is raised, the detents 96 move out from the recesses 98, moving the door 12 away from the gaskets 70, 74.

Once the chamber 16 has been filled with vials and the door 12 lowered to position the door 12 against the slot 14, the second valve 84 is closed, and the first valve 82 opened to supply compressed air to the channel 76 so as to urge the second gasket 74 against the rear surface of the door 12 to form an airtight seal therewith. The chamber 16 is then evacuated as part of the freeze drying process. As discussed above, due to the sub-atmospheric pressure within the chamber 16, the ambient pressure acting on the front surface 87 of the door 12 forces the door 12 to move towards the slot 14, forcing the second gasket 74 back towards its first position. Eventually, the rear surface 58 contacts the first, fixed gasket 70. As the pressure in the chamber 16 continues to decrease, typically to around several microbar, the pressure acting on the front surface 87 of the door 12 urges the door 12 further against the first gasket 70 so that an airtight seal becomes formed between the first gasket 70 and the door 12 as the second gasket 74 is moved back into its stowed position. As the airtight seal between the door 12 and the second gasket 74 is now redundant, the first valve 82 can be closed and the first valve 84 opened to release the compressed gas from the channel 76.

Once the freeze drying process has been completed, the chamber 16 is returned to an ambient pressure. As the pressures acting on the front and rear surfaces of the door equalise, the strength of the seal formed between the door 12 and the first gasket 70 reduces to enable the door 12 to be subsequently raised to enable the freeze-dried vials to be removed from the chamber 16.

While the foregoing description and drawings represent the preferred embodiments of the present invention, it will be apparent to those skilled in the art that various changes and modifications may be made therein without departing from the true spirit and scope of the present invention.

1. An apparatus for closing an opening in a chamber, the apparatus comprising a door, means for moving the door against the opening, a first gasket extending around the opening, a second gasket extending around the first gasket and having a sealing surface, and gasket moving means for moving the sealing surface relative to the door between a first position at which the first gasket forms an airtight seal with the door and a second position at which the second gasket forms an airtight seal with the door.

2. The apparatus according to claim 1 wherein the second gasket is located in a channel extending about the first gasket.

3. The apparatus according to claim 2 wherein the gasket moving means comprises means for conveying a fluid to the channel to move the second gasket towards the second position.

4. The apparatus according to claim 3 wherein the fluid is a pressurised gas.

5. The apparatus according to claim 3 further comprising means for releasing fluid from the channel.

6. The apparatus according to claim 5 wherein the means for releasing fluid from the channel comprises a valve.

7. The apparatus according to claim 1 wherein the first gasket is a fixed gasket.

8. The apparatus according to claim 1 further comprising a fixed member for restraining movement of the door away from the opening.

9. The apparatus according to claim 8 wherein the fixed member comprises a frame connected to the chamber.

10. The apparatus according to claim 1 wherein the chamber is part of a freeze dryer.

11. A freeze dryer comprising a chamber having a slot through which containers can be inserted into the chamber, a slot door, means for moving the slot door against the slot, a first gasket extending around the slot, a second gasket extending around the first gasket and having a sealing surface, and gasket moving means for moving the sealing surface relative to the slot door between a first position at which the first gasket forms an airtight seal with the slot door and a second position at which the second gasket forms an airtight seal with the slot door.

12. The freeze dryer according to claim 11 wherein the second gasket is located in a channel extending about the first gasket.

13. The freeze dryer according to claim 12 wherein the gasket moving means comprises means for conveying a fluid to the channel to move the second gasket towards the second position.

14. The freeze dryer according to claim 13 further comprising means for releasing fluid from the channel.
